(19) United States
(12) Patent Application Publication
(10) Pub. No.: US 2026/0285355 A1
(43) Pub. Date: Sep. 24, 2026

(54) Safety System for Moving Equipment

(71) Applicant: Darrin Iams, West Alexander, PA (US)

(72) Inventor: Darrin Iams, West Alexander, PA (US)

(21) Appl. No.: 19/274,948

(22) Filed: Jul. 21, 2025

Related U.S. Application Data
(60) Provisional application No. 63/773,654, filed on Mar. 18, 2025.

(51) Int. Cl. B60W 50/16; G06V 20/58

(52) U.S. Cl. CPC B60W 50/16; G06V 20/58

(57) ABSTRACT

A safety system that includes at least one motion sensor in, on, or associated with moving equipment; at least one video camera in, on, or associated with the moving equipment; and an artificial intelligence program or device that uses input from the at least one motion sensor and the at least one video camera to determine a dangerous situation is or may be occurring related to the moving equipment and provides a warning to at least one operator of the moving equipment. Also, associated methods.

### CROSS REFERENCE TO RELATED APPLICATION

This application claims the benefit of U.S. Provisional Patent Application No. 63/773,654 filed 18 Mar. 2025 with the same title and in the same inventor's name. This provisional application is hereby incorporated by reference as if fully set forth herein.

### STATEMENT REGARDING FEDERALLY SPONSORED RESEARCH OR FUNDING

None.

### NAMES OF PARTIES TO A JOINT RESEARCH AGREEMENT

None.

### INCORPORATED BY REFERENCE STATEMENT

None.

### STATEMENT REGARDING PRIOR DISCLOSURES BY THE INVENTOR OR A JOINT INVENTOR

None.

### REFERENCE TO SEQUENCE LISTING, A TABLE, OR A COMPUTER PROGRAM LISTING COMPACT DISK APPENDIX

None.

### BACKGROUND OF THE INVENTION

The background of this invention is.

### BRIEF SUMMARY OF THE INVENTION

Aspects and/or embodiments of the disclosed technology may include a safety system with at least one motion sensor in, on, or associated with moving equipment; at least one video camera in, on, or associated with the moving equipment; and an artificial intelligence program or device that uses input from the at least one motion sensor and the at least one video camera to determine a dangerous situation is or may be occurring related to the moving equipment and provides a warning to at least one operator of the moving equipment.

### BRIEF DESCRIPTION OF THE SEVERAL VIEWS OF THE DRAWINGS

The Figures illustrate non-limiting aspects of the subject technology.

FIG. 1 illustrates a possible system according to aspects of the subject technology.

FIG. 2 illustrates some further details of possible artificial intelligence (AI) features of a system according to aspects of the subject technology.

### DETAILED DESCRIPTION OF THE INVENTION

### I. Problem(s)

Moving pieces of equipment are powerful and potentially dangerous devices in everyday use. As used herein, the terms “moving equipment,” “moving pieces of equipment,” and the like are not limited to equipment that is actually moving but rather encompasses equipment capable of moving.

The potential danger of moving equipment in industrial situations is often heightened due to the possible noise, traffic density, and/or general complexity of such environments that can distract operators (e.g., drivers). Such factors may impact even the most skilled operators of moving equipment. Examples of such moving equipment include but are not limited to cars, trucks, vans, forklifts, cement handlers, molten metal handling equipment, and/or any other types of equipment. The term “vehicles” is used interchangeably herein with moving equipment, even though such equipment may or may not have wheels, tracks, and/or treads.

People are usually involved with handling moving equipment especially in industrial environments. While people are essential, they only have a limited field of view. A typical person can see in about a 90° arc of range. This means people typically cannot see about ¾ of their environment at once. The unviewed area(s) create danger zone(s) with a potential for accidents and injury.

People have natural blind spots within their normal field of view. Blind spots also can be created by the equipment. Industrial equipment in particular may have large elements that physically block an operator's field of view. These blind spots further create danger zone(s) with a potential for accidents and injury.

Even if cameras are provided, highly skilled let alone normal operators can process only a limited amount of information at once. Accidents can happen in a split second.

The inventor has personal knowledge of when accidents have occurred in danger zones as described above, for example due to the above described and/or other factors. Some of these accidents resulted in significant harm and hospitalization. Fortunately, the inventor's experience does not include any fatalities. Unfortunately, fatalities have occurred in the above-described danger zones.

The problem(s) discussed above are intended to describe possibly limiting and/or non-limiting aspect(s) of the invention(s) disclosed herein.

### II. Solution(s)

Aspects of the subject technology provide a potential solution to the above and/or other problems via what the inventor refers to as a “Spotter 360 by ONT™” system. This term is not intended to be limiting.

The subject technology offers a possible resolution to these and/or additional challenges through a system the inventor calls the “360 Spotter by ONT™.” This name is not meant to restrict its scope or interpretation.”

The system is intended to be particularly applicable to industrial environments such as but not limited to construction areas, airport tarmacs (luggage buggies, airplane tow vehicles, etc.), warehouses, oil and gas facilities, manufacturing sites inside and outside, distribution warehouses, etc. However, the subject technology may also be applicable more generally. For example, parking lots can be basically “bumper cars” on a busy day.

The Spotter 360 by ONT™ preferably may be installed on any piece of equipment that requires an operator. Examples include but are not limited to vehicles as described above.

The system's intended purpose is to keep people out of harm's way and hopefully prevent injuries maybe even save lives. The system is conceived to use infrared motion sensors for 270° of the equipment, 360° cameras, artificial intelligence (AI), and/or other elements to detect if somebody would step into a “danger zone” of the equipment. Other types of sensors and/or monitors such as motion detectors, pressure sensors, and/or other types of sensors may be used. Incorporation of multiple types of sensors preferably provides redundancy for detecting and/or recording dangerous situation(s).

The terms 270° and 360° should not be read as exact or limiting but rather descriptive of general intent. Different degrees of observation by various elements of the subject technology may be used to define the danger zone around a piece and/or pieces of moving equipment. For example, motion sensors may cover a full 360° around a piece of equipment. Coverage of a danger zone may be adjustable through an application, program, and/or physical and/or software based control panel.

The danger zone may also include a distance for a potential hazard. For example, a person stepping within 2½% feet behind and/or near moving equipment may be considered in the danger zone. This distance preferably is also adjustable.

If a dangerous situation is detected by the system, a warning should be provided to an operator of the equipment. The warning preferably is observed and/or felt by the operator regardless of where the operator is looking, hence preferably a 360° warning.

Examples of the warning include but are not limited to strobe lights, claxon bells, other flashing lights, vibration through an operator's seat, and/or in other manners. Vibration may be provided via triggered high powered electromagnets, relays, and/or other vibration devices. Electromagnets may include iron core(s) wrapped with wire, triggered high powered neodymium magnets, and/or in any other way possible.

Examples of alerts encompass, but are not restricted to, strobe lights, claxon bells, additional flashing signals, seat vibrations for the operator, and/or other methods. Vibrations can be delivered through activated relays or other vibration mechanisms.

Relays might consist of iron core(s) encased in wire, activated powerful rare-earth magnets, or any other feasible configuration.

Relays often consist of an iron core encased in wire, though the design can vary depending on the type and purpose of the relay. In a typical electromagnetic relay, there is a coil made of wire (usually copper) wrapped around a soft iron core. When an electric current flows through the coil, it generates a magnetic field that magnetizes the iron core, which then attracts a movable armature to open or close the relay's contacts, completing or interrupting a circuit. The iron core enhances the magnetic field strength, making the relay more efficient.

Other forms of relays may be used. For example, some relays are based on solid state technology not involving an iron core or wire. Aspects of the subject technology may use iron core, wired, non-wired, and/or other forms of switching technology.

In some cases, equipment may be operated remotely. Such operation typically provides an even more limited field of view for the operator. After all a small screen provided a limited field of view. Also, remote operators often handle multiple pieces of equipment simultaneously. Hence a warning of a dangerous situation for one piece of equipment is particularly important. The warning preferably highlights which piece of equipment is placing people in danger. This type of warning may include sounding an audible alert, flashing a warning on a relevant monitor, providing vibration as discussed above, and/or in any other relevant and effective fashion.

A notification such as described above may also be provided when a dangerous situation has ceased to exist. Also, recording may be made of an entire incident from inception to conclusion. Recording of what occurred before and/or after a dangerous situation may also occur. For example, video feeds, sensor data, and/or other relevant data may be recorded. The recorded information may be sent to a supervisor, administrator, person responsible for safety, and/or others. The information may be used to take corrective action intended to prevent recurrence of a dangerous situation. Recorded information also may be preserved for litigation purposes, and/or for any other reason.

Regarding the AI, it preferably is taught and/or configured to highlight a dangerous situation, a person or people in danger, and/or other related factors. An example of highlighting is placing a “box” on a monitor screen showing any and/or all these things. The AI may also designate what to record.

Modern Als can distinguish people from other objects. For example, boxes and shelves do not exhibit heat and/or motion signatures in a like manner as people. Detection of people versus other elements of an environment preferably is incorporated into aspects of the subject technology.

More advanced versions of the AI aspects include learning from failures. Unfortunately, even with the subject technology people will be hurt. The AI preferably is programmed to learn from these failures by itself and/or others, recorded information from any source, etc. The AI then preferably and hopefully can use its learning to better use the information provided to it.

Note: The term AI is not limited to the singular. In some embodiments a single and/or multiple Als may be involved.

In preferred embodiments, safety system(s) as described herein are self-powered. Power may be provided by batteries, motion powered electrical generations, and/or in any other manner. Alternatively, the system may be powered via connection to an electrical system of the moving equipment. For instance, the system could be energized by linking it to the electrical framework of the mobile machinery.

An administrator and/or other authorized person may turn the system, parts of the system, and/or notification from some and/or all parts of the system on and/or off. For example, in some situations many encroachments upon a danger zone may be detected during a normal course of business. Warnings from such normal operations may distract from warnings regarding actual dangerous situations. Thus, this feature is intended to screen actual dangerous situations from normal operations. Such an operation may be referred to as an “override.” Examples of overrides may be set using a timer, for example covering 5 seconds, 10 seconds, 5 minutes, 10 minutes, an entire day, a week, or for any other period of time.

In preferred aspects, three motion sensors may be configured on both sides and in the back of the equipment. All three preferably run through their own diode protected relay to send information to another relay with a timer that allows overrides as discussed above. A different number of sensors may be used.

Diodes and/or other shielding elements preferably are incorporated into relevant communication lines so a signal from one sensor does not cause a “false positive” from another sensor. Various forms of distinguishing which sensor detects a dangerous situation, for example digital fingerprinting, may also be used in addition and/or in place of physical configuration using diodes or the like.

The Spotter 360 by ONT™ is able to be installed on any piece of equipment and it's purpose is to keep people out of harms way by using infrared motion sensors on 270° of the equipment if somebody a person or an object would step into the danger zone of the equipment the enters sensors will trigger a series of strobe lights that can be seen from 360° of the piece of equipment as well as the driver will have a vibration effect to the seat that he's sitting in and it will tell them continue until the person or object is no longer in the danger zone of the ef-.tt:l.e equipment it's accompanied by an AI 360 camera system that puts a square, possibly flashing, around any person when they come in view of the camera. Many people have see the television show “Person of Interest” which shows an example of placing a “box” around a person. The subject technology is not limited to such.

Once the person gets in the danger zone (example 2½ feet), it will also start recording the data while they're in the danger zone and will show up on the screen as they approach.

By incorporating two (or possibly more) distinct sensors to detect individuals, the system ensures redundancy, enhancing safety and allowing people to move out of danger effectively.” The camera system will also take a video and send it to the admin of the customer's choice that once it is signaled the safety person will be able to logon to that specific piece of equipment and see what the cameras see. This will add an extra layer of safety between the driver of the piece of equipment and any other worker on the job site as well as objects that he could run into while backing up or turning around in the blind spots of the piece of equipment.

The spotter guardian 360 aka Spotter 360 by ONT™ camera(s) and/or system can be installed on any piece of equipment. Power preferable is provided by an isolated battery not directly linked to a vehicle. Of course direct linkage to a vehicle battery also can be used, possibly in combination.

In preferred aspects, the safety system according to aspects of the subject technology is isolated from other parts of equipment/vehicle. In other aspects the system may be partially or fully integrated with the relevant equipment/vehicle.

For example, the safety system may be a standalone system that is not connected into any of the wiring on the equipment/vehicle except possibly a battery for power. Again, independent power may also be used.

In preferred aspects, some or all of a system according to aspects of the subject technology may be installed, uninstalled, removed, disconnected, and/or otherwise enabled and/or disabled.

For example, sensors may just simply be attached to a battery so as not to be invasive to the piece of equipment. Preferably the system and/or its components can be installed and uninstalled very easily with a system of wiring conduit sensors and cameras. Heavy duty magnets and/or other attachment mechanisms may be used.

In more detail, preferred embodiments of the system and/or parts thereof operate independently, avoiding integration with the equipment's existing wiring. Connects preferably is solely to a battery, making the system and/or components non-invasive and allowing for easy installation and removal. The wiring, conduit, sensors, and/or cameras are all preferably mounted onto the equipment using heavy-duty magnets.

A description of a possible relay system configuration follows:

Three motion sensors (more or less may be used) are configured on both sides in the back of the equipment. Preferably all three run through their own diode protected relay which go into another relay with a timer that will allow someone to override the system momentarily in the event that the equipment is working in a very tight area that would be into the danger zone. Times could be sent from five seconds to ten minutes, depending on what the purchaser of the equipment thinks is needed. Other time frames may be used. Setting time frames preferably will allow an equipment/vehicle operator to concentrate on doing their work.

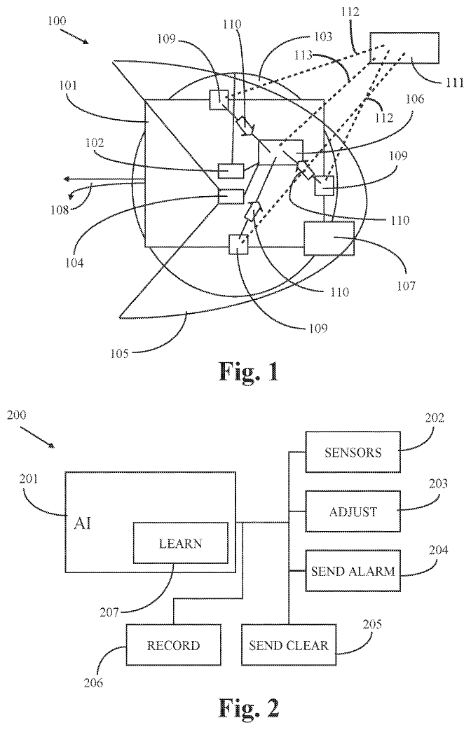

FIG. 1 illustrates a possible system according to aspects of the subject technology. Safety system 100 is provided for moving and/or potentially moving equipment 101. Video camera(s) 102 cover an area 103 around the equipment, shown here as 360° coverage. Motion sensor(s) 104 cover an area 105 around the equipment outside of an operator's field of view, shown here as a 270° of coverage. Artificial intelligence device or software 106 uses input from at least video camera(s) 102 and motion sensor(s) 104 to provide a warning to operator(s) of equipment 101 that a dangerous situation may be occurring.

Element 107 represents brakes for tires, treads, tracks, and the like that may be activated by artificial intelligence 106 if a dangerous situation is detected. Other preventive measures may also be deployed by artificial intelligence 106.

Arrows 108 illustrate that system 100 may be on equipment that is moving possibly in various directions. Various elements of system 100 preferably account for such movement. In one example, artificial intelligence device or software 106 has access to global positioning system (GPS) information (not shown) so as to account for such movement.

FIG. 1 also shows sensors 109, relays 110 preferably including diodes and/or other shielding from other sensors, master relay 111 that may send information to artificial intelligence 106, communication/control lines 112, and communication 113 between between master relay 111 and artificial intelligence 106.

While the elements in FIG. 1 are shown as being located on equipment 101, some and/or all of these elements may be located remotely. For example, motion sensors and video cameras may be in a facility where equipment 101 is being operated. Also, artificial intelligence 106 may be remotely linked and reside in an entirely separate location.

The invention is not limited to the particular details of the embodiment illustrated in FIG. 1. Rather this embodiment represents one possible implementation of the invention disclosed herein.

FIG. 2 illustrates some further details of possible artificial intelligence (AI) features of a system according to aspects of the subject technology. The artificial intelligence 201 preferably takes input from motion and video sensors 202, adjusts 203 the input based on an operating environment to detect people versus fixed objects, sends an alarm 204 (e.g., strobe lights, vibration, claxon bells, etc. as discussed above) if a dangerous situation is detected. Send clear 205 may be activated if artificial intelligence 201 determines the dangerous situation has abated. Element 206 represents recording of relevant data regarding a dangerous situation. The artificial intelligence may learn 207 from prior dangerous situations, preferably enhancing its ability to predict, account for or discount, and otherwise properly react to future potentially dangerous situations.

### III. Generality

The invention is in no way limited to the specifics of any particular aspects disclosed herein. For example, the terms “aspect(s),” “embodiment(s),” “element(s),” “represents,” “illustrates,” “example(s),” “e.g.,” “possible,” “possibly,” “preferably,” “preferred,” “can,” “may,” “likely,” “generally,” “of note,” “note,” and the like denote features that may be preferable but not necessarily essential to include in some embodiments of the invention.

Additional element(s) may be added to various aspects of the invention and/or some disclosed element(s) may be subtracted from various aspects of the invention without departing from the scope of the invention. Singular element(s) imply plural element(s) and vice versa.

Details illustrated or disclosed with respect to any one aspect of the invention may be used with other aspects of the invention. The term “and” generally includes “or” and vice versa. Many other variations/embodiments are possible which remain within the content, scope, and spirit of the invention, and these variations/embodiments would become clear to those skilled in the art after perusal of this application.

What is claims is:

1. A safety system comprising:
at least one motion sensor in, on, or associated with moving equipment;
at least one video camera in, on, or associated with the moving equipment; and
an artificial intelligence program or device that uses input from the at least one motion sensor and the at least one video camera to determine a dangerous situation is or may be occurring related to the moving equipment and provides a warning to at least one operator of the moving equipment.

2. The safety system as in claim 1, wherein the system operates when the moving equipment is moving.

3. The safety system as in claim 1, wherein the system operates when the moving equipment is not moving.

4. The safety system as in claim 1, wherein the at least one motion sensor covers an area outside of a field of view of an operator of the moving equipment.

5. The safety system as in claim 4, wherein the area comprises a 270° field of coverage.

6. The safety system as in claim 1, wherein the at least one video camera covers a 360° field of view.

7. The safety system as in claim 1, wherein the artificial intelligence distinguishes people from fixed objects.

8. The safety system as in claim 1, wherein the artificial intelligence can be configured to control a field of coverage of the at least one motion sensor, the field of view of the at least one video camera, or both.

9. The safety system as in claim 1, wherein the warning comprises a vibration on a seat of an operator of the moving equipment.

10. The safety system as in claim 1, wherein the warning comprises strobe lights, a projected box on a video feed from the at least one video camera, or some combination thereof.

11. A safety method comprising:
using at least one motion sensor in, on, or associated with moving equipment;
using at least one video camera in, on, or associated with the moving equipment; and
using an artificial intelligence program or device that uses input from the at least one motion sensor and the at least one video camera to determine a dangerous situation is or may be occurring related to the moving equipment and provides a warning to at least one operator of the moving equipment.

12. The safety method as in claim 1, wherein the system operates when the moving equipment is moving.

13. The safety method as in claim 1, wherein the system operates when the moving equipment is not moving.

14. The safety method as in claim 1, wherein the at least one motion sensor covers an area outside of a field of view of an operator of the moving equipment.

15. The safety method as in claim 4, wherein the area comprises a 270° field of coverage.

16. The safety method as in claim 1, wherein the at least one video camera covers a 360° field of view.

17. The safety method as in claim 1, wherein the artificial intelligence distinguishes people from fixed objects.

18. The safety method as in claim 1, wherein the artificial intelligence can be configured to control a field of coverage of the at least one motion sensor, the field of view of the at least one video camera, or both.

19. The safety method as in claim 1, wherein the warning comprises a vibration on a seat of an operator of the moving equipment.

20. The safety method as in claim 1, wherein the warning comprises strobe lights, a projected box on a video feed from the at least one video camera, or some combination thereof.
